(19) United States
(12) Patent Application Publication
(10) Pub. No.: US 2007/0037063 A1
(43) Pub. Date: Feb. 15, 2007

(54) Lithium secondary battery

(76) Inventors: Nam-Soon Choi, Suwon-si (KR); Sung-Soo Kim, Suwon-si (KR); Kyoung-Han Yew, Suwon-si (KR); Kyu-Youl Lee, Suwon-si (KR)

Correspondence Address: CHRISTIE, PARKER & HALE, LLP, PO BOX 7068, PASADENA, CA, 91109-7068, US

(21) Appl. No.: 11/482,512

(22) Filed: Jul. 7, 2006

(30) Foreign Application Priority Data
Jul. 7, 2005 (KR) 10-2005-0061126

(51) Int. Cl. H01M 10/04; H01M 4/58

(52) U.S. Cl. 429/330; 429/231.95; 429/200

(57) ABSTRACT

Disclosed is a rechargeable lithium battery including an electrolyte comprising an ethylene carbonate compound represented by Formula 1, a non-aqueous organic solvent, and a lithium salt; a negative electrode including a negative active material including a silicon-included alloy and being capable of reversibly forming a compound by reacting with lithium; and a positive electrode including a positive active material comprising a compound being capable of reversibly intercalating and deintercalating lithium ions or a material capable of forming a compound containing lithium by reversibly reacting with lithium. 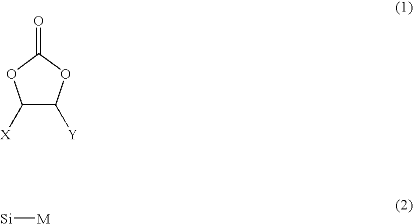
(wherein X and Y are each independently selected from the group consisting of a hydrogen, a halogen, and a fluorinated alkyl having C₁ to C₅; at least one of X and Y is selected from the group consisting of a halogen, and a fluorinated alkyl having C₁ to C₅; and M is at least one selected from the group consisting of Al, Sn, Ag, Fe, Bi, Mg, Zn, In, Ge, Pb, and Ti.)

### CROSS REFERENCE TO RELATED APPLICATION

This application claims priority of Korean application No. 10-2005-0061126, filed in the Korean Intellectual Property Office on Jul. 7, 2005, the entire disclosures of which is incorporated hereinto by reference.

### FIELD OF THE INVENTION

The present invention relates to a rechargeable lithium battery and more particularly, to a rechargeable lithium battery with high capacity and exhibiting improved cycle-life characteristics.

### BACKGROUND OF THE INVENTION

As lithium secondary batteries including non-aqueous electrolytes are known to generate a high voltage, and have a high energy density and good storage characteristics as well as good operability at a low temperature, they are widely applied to portable personal electronic devices. Recently, there are demands to develop thin batteries exhibiting high capacity.

According to such demands, much research regarding high capacity batteries as well as metallic materials such as Si, An, and Al that exhibit higher capacity and may replace carbonaceous active materials, has actively been undertaken.

This is mainly due to the problems of cycle characteristics being degenerated by a series of processes of intercalating and deintercalating lithium ions with metals such as Si, Sn, and Al, and consequential expansion and contraction of the volume thereof, which pulverizes the metal.

In order to attempt to solve these problems, an amorphous metal has been suggested in Y. Idota, et al: Science 276, 1395(1997)), and an amorphous alloy was put forth in the proceedings of the 43^{rd} Battery Symposium in Japan (The Electrochemical Society of Japan, The Committee of Battery Technology, Oct. 12, 2002, p. 308-309).

Conventionally, it is difficult to produce an amorphous Si or Si-included alloy, but the recent development of mechanical alloy techniques has allowed the ready rendering of an amorphous Si-based material.

The amorphous Si-included alloy has higher initial capacity retention, but lower cycle-life characteristics than a crystalline alloy. Furthermore, the expansion of the alloy upon charging is lower than that of a crystalline material, and deterioration caused by repeated charge and discharge is lower than that of the crystalline material, because the amorphous material has various structures compared to crystalline material having one structure (the proceedings of the 43^{rd} Battery Symposium in Japan, The Electrochemical Society of Japan, The Committee of Battery Technology, Oct. 12, 2002, p. 308-309).

The mechanical alloy techniques render easily production of an amorphous alloy, but cause many problems such as a decrease in cycle-life characteristics. This is caused by breaks between the interfaces of the minute alloy that are unidentified by X-ray diffraction analysis, destruction and pulverization of the alloy upon repeated intercalation and deintercalation of lithium when pulverization and pressure are repeatedly applied, and agglomeration while crystallinity is slowly decreased to produce the amorphous.

### SUMMARY OF THE INVENTION

It is an aspect of the present invention to provide a rechargeable lithium battery with a high capacity and that exhibits improved cycle-life characteristics.

These and other aspects may be achieved by a rechargeable lithium battery including an electrolyte, a negative electrode and a positive electrode. The electrolyte includes an ethylene carbonate-based compound represented by Formula 1, a non-aqueous organic solvent, and a lithium salt. The negative electrode includes a negative active material including a silicon-included alloy represented by Formula 2, and being capable of reversibly forming a lithium-included compound by reversibly reacting with lithium. The positive electrode includes a compound being capable of reversibly intercalating and deintercalating lithium ions or a material being capable of forming a lithium-included compound by reversibly reacting with lithium.

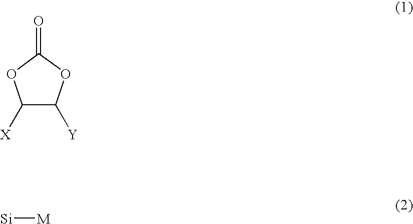

wherein X and Y are each independently selected from the group consisting of hydrogen, a halogen, and a fluorinated alkyl having C₁ to C₅; at least one of X and Y is selected from the group consisting of a halogen, and a fluorinated alkyl having C₁ to C₅; and M is at least one selected from the group consisting of Al, Sn, Ag, Fe, Bi, Mg, Zn, In, Ge, Pb, and Ti.

The rechargeable lithium battery has a SEI (Solid Electrolyte Interphase) film including LiF on a surface of the negative electrode when the rechargeable lithium battery is charged and discharged at 0.05 to 0.5C once or twice. The content of LiF is preferably 1 to 20% by weight based on the total weight of the SEI layer.

### BRIEF DESCRIPTION OF THE DRAWINGS

FIG. 1 is a graph showing cycle-life characteristics of the rechargeable lithium cells according to Example 2 of the present invention and Comparative Example 1;

FIG. 2 is a graph showing FT-IR spectra of the SEI layer formed on the surface of the negative electrode according to Example 2 of the present invention and Comparative Example 1;

FIGS. 3A to 3G are graphs showing results of analyzing the surface structures of the negative electrode after charging the cells according to Example 2 of the present invention and Comparative Examples 1 to 3 with X-ray photoelectron spectroscopy; and

FIGS. 4A to 4E are graphs showing depth profiles of negative electrodes of the cells according to Example 2 of the present invention and Comparative Examples 1 to 3.

### DETAILED DESCRIPTION OF THE INVENTION

A silicon-based electrode has a surface covered with a silicon oxide layer (SiOₓ, native layer) having a network structure, by reacting Si with H₂O or O₂ in air as shown below, as opposed to a carbon-based electrode.
—(Si)ₙ+H₂O→—(Si)ₙOH₂ :geminal silanol
—(Si)OH₂→—(Si)ₙOH+H⁺+e⁻:free silanol

Thus, in a carbon-based electrode, lithium ions are intercalated into the carbon-based electrode, whereas in a silicon-based electrode, lithium ions directly react with silicon to form an alloy, so that a Lewis acid such as PF₅ or HF or a decomposed product of lithium salt such as LiPF₆ in electrolyte during charge and discharge causes a break of a Si—Si active network structure in a Si-including active material, and formation of an irreversible Si—F bond.

Such a stable Si—F bond having a high bond strength causes an irreversible reaction of the Si-including active material which results in no role of Si as the active material, thereby decreasing capacity.

Furthermore, a SEI layer including lithium alkyl carbonate and an anionic decomposed product is formed on a surface of the negative electrode, decreasing reversibility of charge and discharge. Si forms an alloy with lithium during charge, thereby expanding the volume, and pulverize so that decomposition of the electrolyte is accelerated.

In the present invention, such problems may be addressed by using an ethylene carbonate-based additive in a rechargeable lithium battery with a Si-included alloy negative active material.

The silicon-included alloy negative active material has a lower concentration of a functional group such as Si—O—H in a silicon oxide layer that is inherently formed on a surface of the active material, compared to an active material of only Si. Thus, the silicon-included alloy negative active material may form a material for producing the SEI layer, which has a more stable structure than the Si active material, thereby improving cycle-life characteristics.

The ethylene carbonate-based additive is earlier reduction-decomposed than an electrolyte including an organic solvent and a lithium salt to form a SEI layer including LiF on a surface of the Si-including active material. Thus, the irreversible reaction of Si—F is prevented and the cycle-life characteristic of the high capacity rechargeable lithium battery is improved.

Furthermore, the LiF does not dissolve in the electrolyte and allows stable SEI layer to be maintained during the charge and discharge cycles, thereby preventing additional decomposition of the electrolyte.

The rechargeable lithium battery of the present invention includes an electrolyte, a negative electrode, and a positive electrode. The electrolyte includes an ethylene carbonate-based compound represented by Formula 1, a non-aqueous organic solvent, and a lithium salt. The negative electrode includes a negative active material including a silicon-included alloy represented by Formula 2, and being capable of forming a lithium-included compound by reversibly reacting with lithium. The positive electrode includes a compound being capable of reversibly intercalating and deintercalating lithium ions or a material being capable of forming a lithium-included compound by reversibly reacting with lithium.

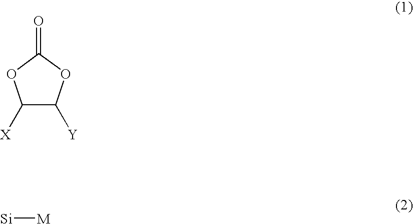

wherein X and Y are each independently selected from the group consisting of hydrogen, a halogen, and a fluorinated alkyl having C₁ to C₅; at least one of X and Y is selected from the group consisting of a halogen, and a fluorinated alkyl having C₁ to C₅; and M is at least one selected from the group consisting of Al, Sn, Ag, Fe, Bi, Mg, Zn, In, Ge, Pb, and Ti.

On the surface of the negative electrode, a SEI layer including a product of an ethylene carbonate-based compound represented by Formula 1 may be formed. More particularly, when the rechargeable lithium battery is charged and discharged at 0.05 to 0.5C once or twice, a SEI layer including LiF is formed on the surface of the negative electrode. The amount of LiF is preferably 1 to 20% by weight based on the total weight of the SEI layer, and more preferably 10 to 20% by weight.

The SEI layer may include a small amount of lithium alkycarbonate.

The LiF in the SEI layer protects against a decomposition of the electrolyte on the surface of the negative electrode, thereby improving cycle-life characteristics of the rechargeable lithium battery, and prevents additional decomposition of the electrolyte upon repeated charge and discharge cycles. Even though LiF has such advantages, however, the ability to transfer lithium ions is slightly lower than that of lithium alkylcarbonate so that it is preferred that the amount of LiF does not exceed 20% by weight of the SEI layer.

The SEI layer preferably has a thickness of 5 Å to 50Å, more preferably 10 Å to 30 Å, and most preferably 20 Å to 30 Å. If the thickness is less than 5 Å, the durability of the SEI layer is decreased with the repeated charge and discharge, and with repeated temperature change. Whereas if the thickness is more than 50 Å, resistance of the SEI layer is increased, decreasing charge and discharge efficiency.

The ethylene carbonate-based compound is preferably represented by the following Formula 1:

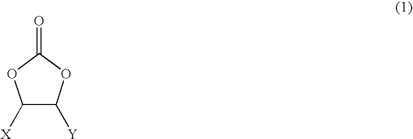

wherein X and Y are each independently selected from the group consisting of hydrogen, a halogen, and a fluorinated alkyl group having C₁ to C₅ and at least one of X and Y is selected from the group consisting of a halogen, and a fluorinated alkyl group having C₁ to C₅.

Specific examples of the ethylene carbonate-based compound may include, but are not limited to, fluoroethylene carbonate, fluoropropylene carbonate, fluoro γ-butyrolactone, chloroethylene carbonate, chloropropylene carbonate, chloro γ-butyrolactone, bromoethylene carbonate, bromopropylene carbonate, bromo γ-butyrolactone, and a mixture thereof. More preferably, the ethylene carbonate-based compound is fluoroethylene carbonate.

The ethylene carbonate-based compound represented by Formula 1 may be preferably present in an amount of 0.1% to 10% by weight based on the total weight of the electrolyte, more preferably 3 to 7% by weight, and most preferably 1% to 5% by weight. When the ethylene carbonate-based compound is present in an amount of less than 0.1% by weight, the surface of the negative electrode is insufficiently coated and the cycle-life characteristics are deteriorated. On the other hand, if the amount of the ethylene carbonate-based compound is more than 10% by weight, the viscosity of the electrolyte is increased and the cycle-life characteristics are also deteriorated.

A silicon-included alloy represented by Formula 2 and being capable of forming a lithium-included compound by reversibly reacting with lithium, may be used as a negative active material
Si—M (2)

wherein, M is an element selected from the group consisting of Al, Sn, Ag, Fe, Bi, Mg, Zn, In, Ge, Pb, Ti, and combinations thereof.

Preferably M is an element selected from the group consisting of Al, Fe, In and combinations thereof.

The negative active material may preferably include Si in an amount of 30% to 80% by weight based on the total weight of the negative active material, and more preferably 40% to 60% by weight. When Si is included in an amount of less than 30% by weight, charging and discharging of a battery is difficult due to a low effect of Si on the charging and discharging. On the other hand, if the amount of Si is more than 80% by weight, the volume change according to expansion and contraction of a negative active material is increased, and the active material is pulverized, thereby decreasing cycle-life characteristics.

An average particle diameter of the negative active material preferably ranges from 5 μm to 30 μm. Generally, in order to use the Si-including alloy as an active material, it is required to use a conductive agent because the Si-including alloy has higher resistance than a graphite powder negative electrode material of a lithium secondary battery. However, when too-small active material of less than 5 μm which is less than the particle diameter of the conductive agent is used, it is insufficient to work as an active material, and therefore battery characteristics, such as capacity or cycle characteristics are deteriorated. When the average particle diameter is more than 30 μm, packing density of the negative active material in the lithium secondary battery is deteriorated.

The negative active material may be prepared by a conventional method, such as a mechanical alloy technique.

The non-aqueous organic solvent acts as a medium that can transport ions that participate in electrochemical reactions. The non-aqueous organic solvent includes one or at least two selected from benzene, toluene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotolune, 1,2,4-triiodotoluene, R—CN (where R is a C₂-C₅₀ linear, branched, or cyclic hydrocarbon, and may include double bonds, aromatic cycling, or ether bonds), dimethylformamide, dimethylacetate, xylene, cyclohexane, tetrahydrofurane, 2-methyltetrahydrofurane, cyclohexanone, ethanol, isopropyl alcohol, dimethyl carbonate, ethylmethyl carbonate, diethyl carbonate, methylpropyl carbonate, methyl propionate, ethyl propionate, methyl acetate, ethyl acetate, propyl acetate, dimethoxyethane, 1,3-dioxolane, diglyme, tetraglyme, ethylene carbonate, propylene carbonate, γ-butyrolactone, sulfolane, valerolactone, decanolide, or mevalolactone. If a mixed solvent is used, the mixing ratio may be suitably controlled according to desired battery performance, as may be understood by one skilled in the related art.

The lithium salt acts as a supply source of lithium ions in the battery, making the basic operation of the lithium battery possible. The non-aqueous organic solvent acts as a medium for mobilizing ions to be capable of participating in the electrochemical reaction.

The lithium salt is preferably selected from the group consisting of LiPF₆, LiBF₄, LiSbF₆, LiAsF₆, LiClO₄, LiCF₃SO₃, Li(CF₃SO₂)₂N, LiC₄F₉SO ₃, LiSbF₆, LiAlO₄, LiAlCl₄, LiN(CₓF₂ₓ₊₁SO₂)(C_{y}F_{2y+1}SO₂) (where x and y are natural numbers), LiCl, LiI, an combinations thereof.

The concentration of the lithium salt is preferably in the range of 0.1M to 2 M. When the concentration of the lithium salt is less than 0.1 M, the electrolyte performance deteriorates due to its ionic conductivity. When the concentration of lithium salt is greater than 2 M, the lithium ion mobility decreases due to an increase in electrolyte viscosity.

The positive active material for the lithium battery may include a compound being capable of reversibly intercalating and deintercalating lithium ions or a material being capable of forming a compound containing lithium by reversibly reacting with lithium.

The positive active material may include a composite oxide with lithium including at least one selected from the group consisting of cobalt, manganese, and nickel, and particularly includes a lithium-included compound as follows:
LiₓMn_{1-y}M_{y}A₂ (3)
LiₓMn_{1-y}M_{y}O_{2-z}X_{z} (4)
LiₓMn₂O_{4-z}X_{z} (5)
LiₓMn_{2-y}M_{y}M′_{z}A₄ (6)
LiₓCo_{1-y}M_{y}A₂ (7)
LiₓCo_{1-y}M_{y}O_{2-z}X_{z} (8)
LiₓNi_{1-y}M_{y}A₂ (9)
LiₓNi_{1-y}M_{y}O_{2-z}X_{z} (10)
LiₓNi_{1-y}Co_{y}O_{2-z}X_{z} (11)
LiₓNi_{1-y-z}Co_{y}M_{z}A_{α} (12)
LiₓNi_{1-y-z}Co_{y}M_{z}O_{2-α}X_{α} (13)
LiₓNi_{1-y-z}Mn_{y}M_{z}A_{α} (14)
LiₓNi_{1-y-z}Mn_{y}M_{z}O_{2-α}X_{α} (15)
LiₓNi_{2-y-z}M_{y}M′_{z}A₄ (16)

wherein 0.9≦x≦1.1, 0≦y≦0.5, 0≦z≦0.5, 0≦α≦2; M and M′ may be identical to or different from each other, and they are selected from the group consisting of Mg, Al, Co, K, Na, Ca, Si, Ti, Sn, V, Ge, Ga, B, As, Zr, Ni, Mn, Cr, Fe, Sr, V, and rare earth elements; A is selected from the group consisting of O, F, S, and P; and X is selected from the group consisting of F, S, and P.

The positive active material may further include a compound being capable of reversibly intercalating and deintercalating lithium such as LiFeO₂, V₂O₅, TiS, MoS, an organo disulfide compound, or an organo polysulfide compound.

Further, in addition to the positive electrode, the negative electrode, and the electrolyte, the rechargeable lithium battery may further include, if required, any other material such as a separator interposed between the positive electrode and the negative electrode.

The separator may include any conventional separator, such as a porous polypropylene film or a porous polyethylene film.

The lithium secondary battery of the present invention has improved cycle characteristics because the SEI coating layer formed by ethylene carbonate-based compound prevents the electrolyte from decomposing.

The following examples further illustrate the present invention in detail, but are not to be construed to limit the scope thereof.

### EXAMPLES 1 TO 3, AND COMPARATIVE EXAMPLES 1 TO 6

Electrolytes having composition shown in the following Table 1 were prepared.

In Table 1, the additive amount of the ethylene carbonate-based compound added to non-aqueous electrolyte is shown in units of % by weight (wt %), and the composition ratio of the non-aqueous organic solvent is shown in units of % by volume (vol %), and the amount of lithium salt based on the electrolyte is shown in units of mol/L. In Table 1, FEC, VC, EC, DEC, and LiBOB are abbreviations of monofluoroethylene carbonate, vinylene carbonate, ethylene carbonate, diethylcarbonate, and lithium bis(oxalate)borate, respectively.

TABLE 1

| | | Non-aqueous | | | Ethylene |
|---|---|---|---|---|---|
| | | organic | | | carbonate- |
| | | solvent | | Lithium | based |
| | Negative active material | (volume %) | | salt | compound (wt %) |
| Example 1 | SiAlFe Alloy powder | EC | DEC | LiPF₆ | FEC (0.1) |
| | (Si:Al:Fe = 52:28:20 | (30) | (70) | 1.3M | |
| | weight ratio) | | | | |
| Example 2 | SiAlFe Alloy powder | EC | DEC | LiPF₆ | FEC (3) |
| | (Si:Al:Fe = 52:28:20 | (30) | (70) | 1.3M | |
| | weight ratio) | | | | |
| Example 3 | SiAlFe Alloy powder | EC | DEC | LiPF₆ | FEC (10) |
| | (Si:Al:Fe = 52:28:20 | (30) | (70) | 1.3M | |
| | weight ratio) | | | | |
| Comparative | SiAlFe Alloy powder | EC | DEC | LiPF₆ | — |
| Example 1 | (Si:Al:Fe = 52:28:20 | (30) | (70) | 1.3M | |
| | weight ratio) | | | | |
| Comparative | SiAlFe Alloy powder | EC | DEC | LiBF₄ | — |
| Example 2 | (Si:Al:Fe = 52:28:20 | (30) | (70) | 1.3M | |
| | weight ratio) | | | | |
| Comparative | SiAlFe Alloy powder | EC | DEC | LiBOB | — |
| Example 3 | (Si:Al:Fe = 52:28:20 | (30) | (70) | 1.3M | |
| | weight ratio) | | | | |
| Comparative | SiAlFe Alloy powder | EC | DEC | LiPF₆ | FEC (15) |
| Example 4 | (Si:Al:Fe = 52:28:20 | (30) | (70) | 1.3M | |
| | weight ratio) | | | | |
| Comparative | SiAlFe Alloy powder | EC | DEC | LiPF₆ | VC (3) |
| Example 5 | (Si:Al:Fe = 52:28:20 | (30) | (70) | 1.3M | |
| | weight ratio) | | | | |
| Comparative | Si powder | EC | DEC | LiPF₆ | FEC (3) |
| Example 6 | | (30) | (70) | 1.3M | |

A lithium cobalt oxide (LiCoO₂) active material was mixed with a carbon black conductive agent to prepare a mixture. A polyvinylidene fluoride binder was dissolved in an N-methyl-2-pyrrolidone solvent to prepare a binder solution. The mixture was added to the binder solution to obtain a positive active slurry.

The positive active slurry was coated on a 20 μm aluminum foil by a doctor blade method, and it was dried under a vacuum atmosphere followed by drying it at 120° C. for 24 hours and pressing, thereby producing a positive electrode.

The negative active material shown in Table 1 was ad-mixed to polyviniylidene fluoride in an N-methyl-2-pyrrolidone solution to prepare a negative active material slurry. The negative active slurry was coated on a 14 μm copper foil by a doctor blade method, and it was dried under a vacuum atmosphere followed by drying it at 120° C. for 24 hours and pressing, thereby producing a negative electrode.

Using the positive electrode, the negative electrode, a separator and the electrolyte shown in Table 1, rechargeable lithium cells were fabricated.

(Measurement of Initial Coulombic Efficiency of Rechargeable Lithium Battery Cell)

The rechargeable lithium battery cells according to Examples 1 through 3, and Comparatives Examples 1, 4, 5, and 6 were charged at 0.2C to a cut-off voltage of 4.2V, and then discharged at 0.2C to a cut-off voltage of 3.0V. After the charge-discharge was executed once, initial coulombic efficiencies of the rechargeable battery cells were measured. The results are shown in Table 2.

TABLE 2

| | Initial reversible efficiency |
|---|---|
| Example 1 | 88.1% |
| Example 2 | 90.0% |
| Example 3 | 87.2% |
| Comparative Example 1 | 87.8% |
| Comparative Example 4 | 86.0% |
| Comparative Example 5 | 87.9% |
| Comparative Example 6 | 87.0% |

As shown in Table 2, the rechargeable lithium battery cells of Examples 1 through 3, and Comparatives 1, 4, 5, and 6 had similar initial coulombic efficiency. However, initial coulombic efficiency of the cell according to Comparative 6 using the Si powder negative active material was lower than in Examples 1 through 3 using the Si-included alloy active material.

This is considered to be because the concentration of Si—O—H in the silicon oxide layer having a network structure is higher in Comparative Example 6 than in Examples 1 to 3. The Si—O—H was formed by reacting Si with H₂O, O₂, etc.

Accordingly, in the case of Comparative Example 6, the additive directly reacted with components in the silicon oxide layer to form structures such as Si—O—R, Si—O—Li, or the like, thereby reducing effects of formation of stable materials by using the additives, and decreasing cycle-life characteristics.

(Evaluation of Cell Characteristics)

The cycle-life characteristics were determined on the rechargeable lithium battery cells according to Example 2 and Comparative Example 1.

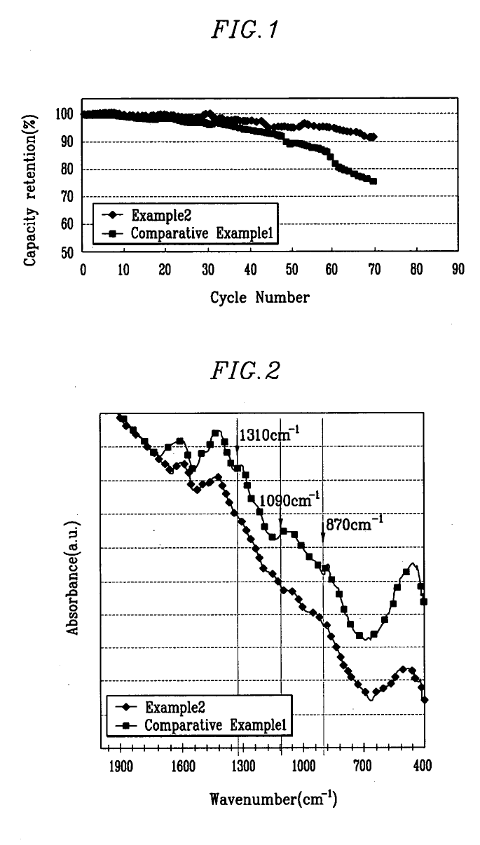

The cells according to Example 2 and Comparative Example 1 were charged at 0.2C to a cut-off voltage of 4.2V and discharged at 0.2C to a cut-off voltage of 3.0V. The charge and discharge cycles were performed 70 times. After 70 cycles, the capacity retention was measured. The results are shown in FIG. 1. The capacity retention is a ratio of discharge capacity after the 70th cycle to discharge capacity after the 1^{st} cycle.

As shown in FIG. 1, until cycle number 30, capacity retention of the battery cell according to Example 2 and Comparative Example 1 were similar. After cycle number 30, capacity retention of the battery cell according to Example 2 was maintained. However, capacity retention of the battery cell according to Comparative Example 1 dropped abruptly, and after cycle number 60, capacity retention was less than 80%. It is evident from the results that the cell according to Example 2 in which the SEI layer was formed on the surface of the negative electrode by the FEC, exhibits better cycle-life characteristics than the cell according to Comparative Example 1 without additives.

(Measurement of SEI Layer Composition)

The battery cells according to Example 2 and Comparative Example 1 were charged at 0.2C to 4.2V and discharged at 0.2C to 3.0V by the same method as in the above evaluation of cell characteristics. The charge and discharge were repeated 100 times. Then, the negative electrodes were washed with dimethylcarbonate. Afterward, the components in the thin layer (SEI layer) were scratched from a copper current collector and that was then coated with a silicon wafer. The SEI layer formed on the surface of the negative electrode was measured by FT-IR (Fourier transform infrared spectroscopy).

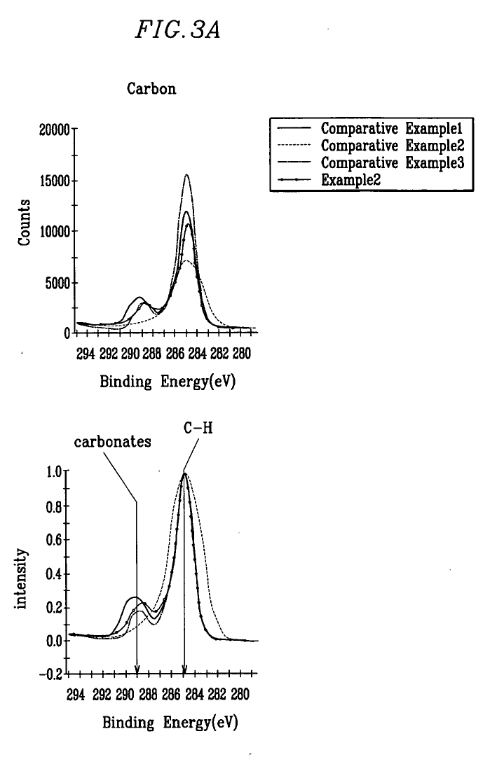

The results are shown in FIG. 2.

In the graph of FIG. 2, P-F(LiₓPF_{y}: 0.01≦x≦1, 1≦y≦6) indicated 866 cm⁻¹, and LiCO₃ indicated 1510-1450 cm⁻¹, and 875-869 cm⁻¹. ROCO₂Li (R=methyl group, ethyl group, propyl group, or butyl group) indicated 1640 cm⁻¹, 1450-1400 cm⁻¹, 1350-1300 cm⁻¹, and 1100 cm⁻¹.

As shown in FIG. 2, compositions of the SEI layer formed on the negative electrode of the battery cell of Example 2 were different from those of Comparative Example 1. In case of Comparative Example 1 not using the additives, the SEI layer mainly included a metastable compound that is a linear-carbonate type of compound (ROCO₂Li: R=methyl group, ethyl group, propyl group, or butyl group) and a decomposed anion product. However, in the case of Example 2, these above compounds were not observed. This is considered to be because of reduce-decomposition of the FEC additive of Example 2 prior to an EC or DEC organic solvent and forming the SEI layer, thereby preventing formation of ROCO₂Li.

(Surface Structure Analysis)

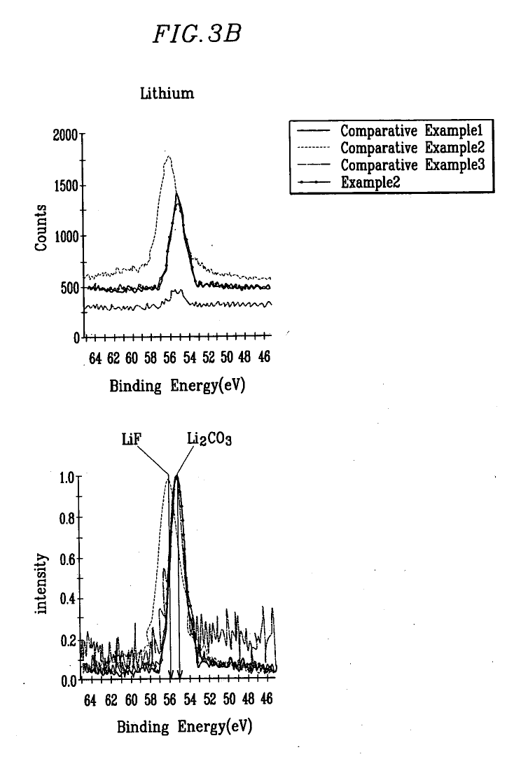

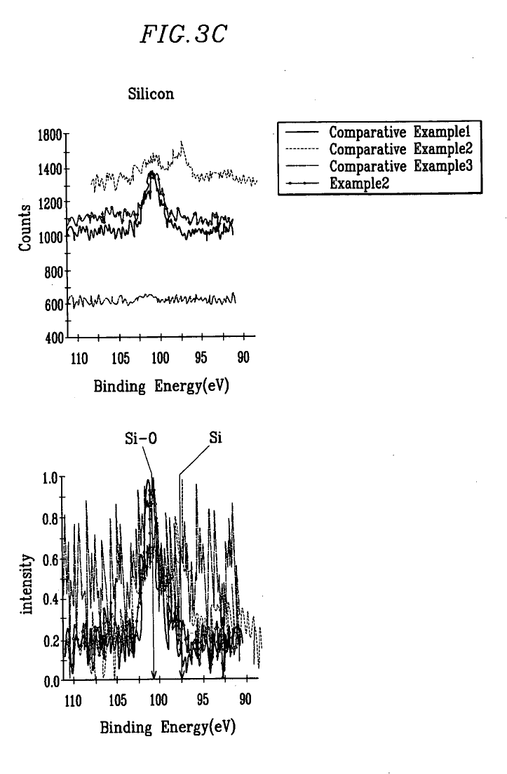

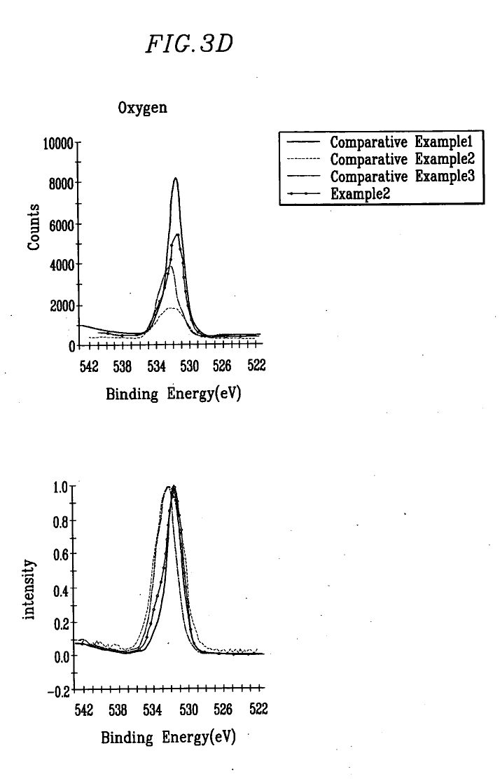

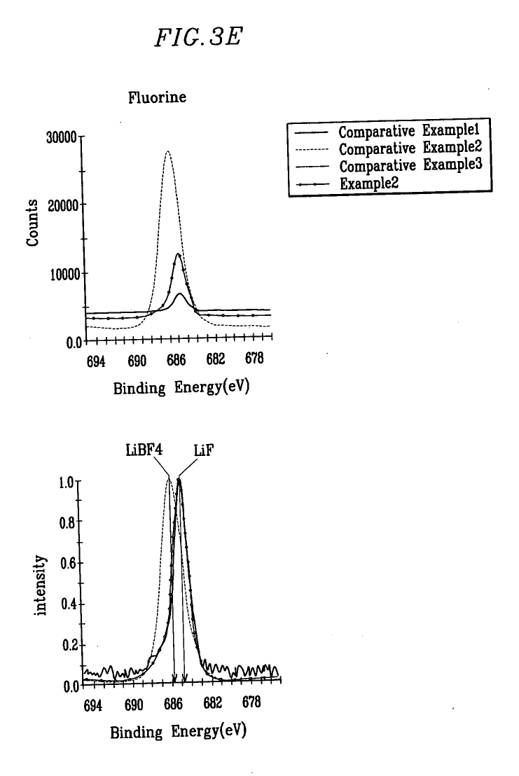

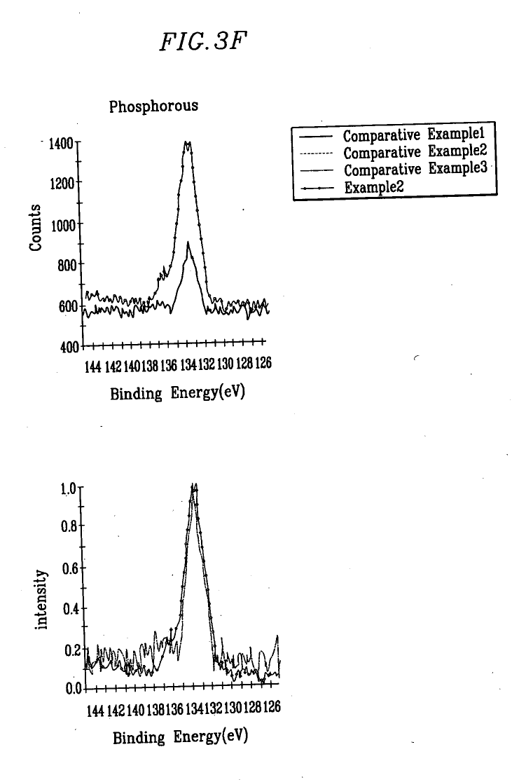

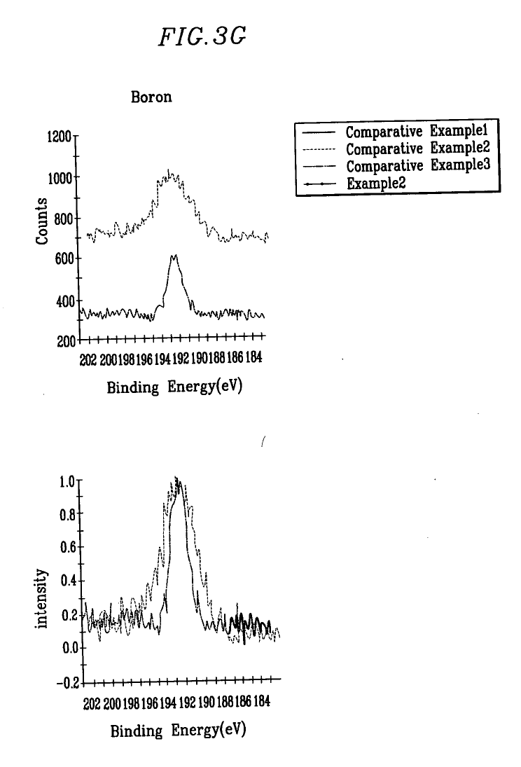

In order to determine effects for cycle-life characteristic by addition of the additive, lithium secondary battery cells according to Example 2 and Comparative 1 to 3 were charged at 0.2C to a cut-off voltage of 4.2V and discharged at 0.2C to a cut-off voltage of 3.0V, the same as in the coating layer element analysis: This charging and discharging was carried out 100 times. After charging and discharging, the surface structure of the negative electrode was analyzed with X-ray photoelectron spectroscopy(XPS-monochromated Al Kα source). The results are shown in Table 3 and FIGS. 3a to 3g.

In FIGS. 3a to 3g, the X-axis indicates a binding energy (eV), and the y-axis indicates intensity.

TABLE 3

| | | | | | | |
|---|---|---|---|---|---|---|
| C (%) | Li (%) | P (%) | B (%) | Si (%) | O (%) | F (%) |

| | | | | | | | |
|---|---|---|---|---|---|---|---|
| Example 2 | 39.3 | 24.7 | 1.5 | 0.0 | 0.3 | 25.2 | 8.9 |
| Comparative | 43.8 | 23.2 | 0.4 | 0.0 | 0.4 | 30.1 | 2.2 |
| Example 1 | | | | | | | |
| Comparative | 26.6 | 38.2 | 0.0 | 2.0 | 0.2 | 8.4 | 24.6 |
| Example 2 | | | | | | | |
| Comparative | 69.8 | 6.0 | 0.0 | 1.7 | 0.0 | 22.5 | 0.0 |
| Example 3 | | | | | | | |

As shown in Table 3, elements included in the SEI layer depend on the electrolyte and an additive.

When comparing only the content of silicon of the active material detected with the SEI layer components, the thickness of the SEI layer including LiPF₆ according to Comparative Example 1 was the thinnest, and the thickness of the SEI layer including LIBOB according to Comparative Example 3 was the thickest. Also, as shown in FIGS. 3a to 3g, the analysis results of elements included in the SEI layer showed that the main component of the SEI layer was LiF according to Example 2 to which the FEC additive was added, but the main component was Li₂CO₃, LiF, and hydrocarbon according to Comparative Examples 1, 2, and 3, respectively.

In particular, in Comparative Example 2, non-decomposed LiBF₄ was detected with LiF and a carbonate-containing layer was not formed. In Comparative Example 3, it was detected that oxygen bonding is not carbonate bonding, but rather indistinct bonding.

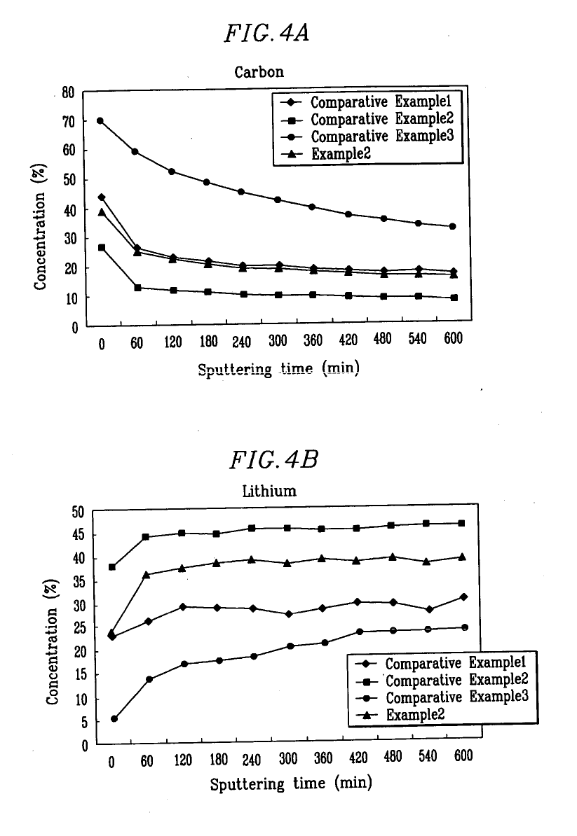

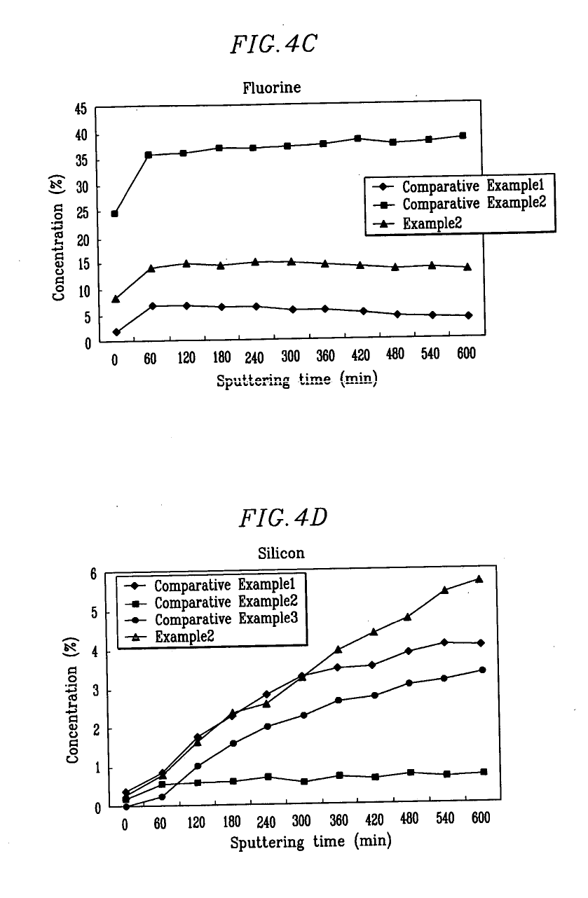

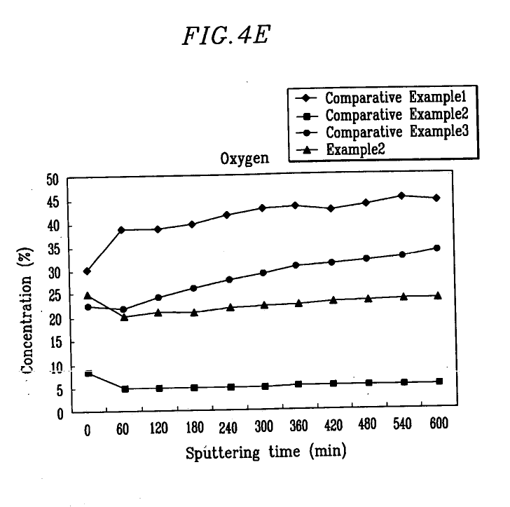

Furthermore, depth profiles were measured by shooting an Ar+ sputtering gun at a 1.0 mA beam current, 3 kV, for the obtained negative electrodes in the battery cells after charging and discharging. The results are shown in the following FIGS. 4a to 4e.

In FIGS. 4a to 4e, the X-axis indicates sputtering time (min), and the y-axis indicates concentration (%).

It is known from FIGS. 4a to 4e that show the chemical composition of the surface of the negative active material according to sputtering time that the composition of the active material surface according to Example 2 is remarkably different from those of Comparative Examples 1 to 3. Furthermore, according to the sputtering time, Si—O and Si—Si bonding were increased in Example 2 and Comparative Example 1, but such an increase did not appear in Comparative Example 2 to 3.

From the detection of Si—Si bonding (Eb≈99.6 eV) by sputtering, it is considered that the thickness of the Si—O oxide film in Comparative Example 1 was thicker than that of Example 2.

In the case of Comparative Example 2, Si—Si bonding was detected initially, but disappeared after sputtering, and only silicon at less than 1% was detected continuously. This is considered because the side reaction of silicon formed on the surface in SEI layer was continued.

The lithium secondary battery of the present invention has an improved cycle characteristics because the SEI layer formed by ethylene carbonate-based compound prevents the electrolyte from decomposing.

What is claimed is:

1. A rechargeable lithium battery comprising:
an electrolyte comprising an ethylene carbonate compound represented by Formula 1, a non-aqueous organic solvent, and a lithium salt;
a negative electrode comprising a negative active material comprising a silicon-included alloy and being capable of reversibly forming a lithium-included compound by reacting with lithium;
a positive electrode comprising a positive active material comprising a compound being capable of reversibly intercalating and deintercalating lithium ions or a material being capable of forming a compound containing lithium by reversibly reacting with lithium: 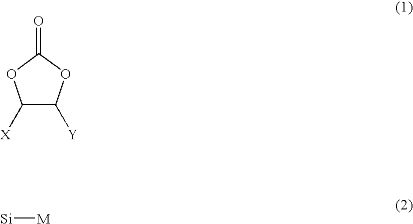
(wherein X and Y are each independently selected from the group consisting of hydrogen, a halogen, and a fluorinated alkyl having C₁ to C₅, at least one of X and Y is selected from the group consisting of a halogen, and a fluorinated alkyl having C₁ to C₅, and M is at least one selected from the group consisting of Al, Sn, Ag, Fe, Bi, Mg, Zn, In, Ge, Pb, and Ti.)

2. The rechargeable lithium battery of claim 1, wherein the negative electrode has a SEI layer comprising LiF on a surface of the negative electrode when the rechargeable lithium battery is charged and discharged at 0.05 to 0.5C once or twice.

3. The rechargeable lithium battery of claim 2, wherein the SEI layer comprises LiF in an amount of 1 to 20% by weight based on the total weight of the SEI layer.

4. The rechargeable lithium battery of claim 2, wherein the SEI layer has a thickness of 5 to 50 Å.

5. The rechargeable lithium battery of claim 1, wherein the ethylene carbonate is selected from the group consisting of fluoroethylene carbonate, fluoropropylene carbonate, fluoro γ-butyrolactone, chloroethylene carbonate, chloropropylene carbonate, chloro γ-butyrolactone, bromoethylene carbonate, bromopropylene carbonate, bromo γ-butyrolactone, and a mixture thereof.

6. The rechargeable lithium battery of claim 1, wherein the ethylene carbonate is present in an amount of 0.1 to 10% by weight based on the total weight of the electrolyte.

7. The rechargeable lithium battery of claim 6, wherein the ethylene carbonate is present in an amount of 3 to 7% by weight based on the total weight of the electrolyte.

8. The rechargeable lithium battery of claim 7, wherein the ethylene carbonate is present in an amount of 1 to 5% by weight based on the total weight of the electrolyte.

9. The rechargeable lithium battery of claim 1, wherein the negative active material comprise Si in an amount of 30 to 80% by weight based on the total weight of the negative active material.

10. The rechargeable lithium battery of claim 1, wherein the negative active material has an average particle diameter of 5 μm to 30 μm.

11. The rechargeable lithium battery of claim 1, wherein the non-aqueous organic solvent is one or at least two selected from the group benzene, toluene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotolune, 1,2,4-triiodotoluene, R—CN (where R is a C₂-C₅₀ linear, branched, or cyclic hydrocarbon, and may include double bonds, aromatic cycling, or ether bonds), dimethylformamide, dimethylacetate, xylene, cyclohexane, tetrahydrofurane, 2-methyltetrahydrofurane, cyclohexanone, ethanol, isopropyl alcohol, dimethyl carbonate, ethylmethyl carbonate, diethyl carbonate, methylpropyl carbonate, methyl propionate, ethyl propionate, methyl acetate, ethyl acetate, propyl acetate, dimethoxyethane, 1,3-dioxolane, diglyme, tetraglyme, ethylene carbonate, propylene carbonate, γ-butyrolactone, sulfolane, valerolactone, decanolide, or mevalolactone.

12. The rechargeable lithium battery of claim 1, wherein the lithium salt is LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (where x and y are natural numbers), L LiI and combinations thereof.

13. The rechargeable lithium battery of claim 1, wherein the lithium salt has a concentration of 0.1 M to 2 M.

14. The rechargeable lithium battery of claim 1, wherein the positive active material is a lithium-including compound selected from the group consisting of compounds represented by the Formulas 3 to 16:
LiₓMn_{1-y}M_{y}A₂ (3)
LiₓMn_{1-y}M_{y}O_{2-z}X_{z} (4)
LiₓMn₂O_{4-z}X_{z} (5)
LiₓMn_{2-y}M_{y}M′_{z}A₄ (6)
LiₓCo_{1-y}M_{y}A₂ (7)
LiₓCo_{1-y}M_{y}O_{2-z}X_{z} (8)
LiₓNi_{1-y}M_{y}A₂ (9)
LiₓNi_{1-y}M_{y}O_{2-z}X_{z} (10)
LiₓNi_{1-y}Co_{y}O_{2-z}X_{z} (11)
LiₓNi_{1-y-z}Co_{y}M_{z}A_{α} (12)
LiₓNi_{1-y-z}Co_{y}M_{z}O_{2-α}X_{α} (13)
LiₓNi_{1-y-z}Mn_{y}M_{z}A_{α} (14)
LiₓNi_{1-y-z}Mn_{y}M_{z}O_{2-α}X_{α} (15)
LiₓNi_{2-y-z}M_{y}M′_{z}A₄ (16)
wherein 0.9≦x≦1.1, 0≦y≦0.5, 0≦z≦0.5, 0≦α≦2; M and M′may be identical to or different from each other, and they are selected from the group consisting of Mg, Al, Co, K, Na, Ca, Si, Ti, Sn, V, Ge, Ga, B, As, Zr, Ni, Mn, Cr, Fe, Sr, V, and rare earth elements; A is selected from the group consisting of O, F, S, and P; and X is selected from the group consisting of F, S, and P.
